(19) United States
(12) Patent Application Publication
(10) Pub. No.: US 2020/0289962 A1
(43) Pub. Date: Sep. 17, 2020

(54) HIGH-PRESSURE FILTER

(71) Applicant: Zhengfeng WANG, Qingdao City (CN)

(72) Inventor: Zhengfeng WANG, Qingdao City (CN)

(21) Appl. No.: 16/815,600

(22) Filed: Mar. 11, 2020

(30) Foreign Application Priority Data
Mar. 15, 2019 (CN) 201910195952.6

(51) Int. Cl. B01D 24/48; B01D 33/27; B01D 33/00

(52) U.S. Cl. CPC B01D 24/48; B01D 33/0074; B01D 33/27

(57) ABSTRACT

A high-pressure filter is provided, which belongs to the field of filter device technologies, and comprises a trough, a filter disc, a power device, a spiral stirring device, and a compressed air storage tank. A sealed housing is disposed outside the trough, and an inner wall of the sealed housing is connected to an outer wall of the trough to form a sealed cavity. The compressed air storage tank is in communication with the sealed cavity, and compressed air is supplied to the sealed cavity to form a high pressure environment in the sealed cavity. Therefore, a pressure difference is formed between the interior and the exterior of the filter disc to improve the filtering efficiency.

### TECHNICAL FIELD

The present invention relates to the field of filter technologies, and in particular, to a high-pressure filter.

### BACKGROUND

A ceramic filter is a new common high-efficiency and energy-saving solid-liquid separation device in the world. The ceramic filter mainly consists of several parts including a roller system, a stirring system, a feeding and discharging system, a vacuum system, a gas distribution system, a filtrate discharging system, a scraping system, a backwashing system, a combined cleaning (ultrasonic cleaning and automatic acid cleaning) system, an automatic control system, a tank body, and a frame. The core part of the filter is a ceramic filter plate, which is also referred to as a ceramic filter film, a ceramic board, a ceramic plate, a filter plate, etc., and is a new filter medium made of corundum, silicon carbide, and so on through special techniques. The ceramic filter plate has the following defects. The ceramic filter plate has a high cost of use, mainly a high cleaning cost, has a complex structure, and needs to be equipped with pickling and ultrasonic systems, thus polluting the environment. The ceramic filter plate is easily blocked, has a short service life and low mechanical strength, and is easily broken during backwashing and vacuuming and not resistant to low temperature. Moreover, due to the limitation of the material, the filtering area cannot be too large, so that the whole machine cannot be enlarged.

### SUMMARY OF THE INVENTION

The technical task of the present invention is to provide a high-pressure filter to solve the defects of the prior art, and in particular to improve the filtering environment and improve the filtering efficiency of the whole machine.

The technical solution adopted by the present invention to solve the technical problem thereof is:

A high-pressure filter comprises: a slurry filled trough, a filter disc built into the trough, and a power device for driving the filter disc to rotate about its own axis. A sealed housing is disposed outside the trough, and an inner wall of the sealed housing is connected to an outer wall of the trough to form a sealed cavity, the surface of the sealed housing is provided with a liquid inlet in communication with the sealed cavity, and an ultrasonic liquid level controller is mounted at the position of the liquid inlet. The filter disc further includes a screw shaft and a filter disc body; two ends of the screw shaft penetrate through the sealed housing outwardly through a bearing block, an end portion of the screw shaft extending out of the sealed housing is provided with a filter cake thickness ultrasonic detector, an end surface of the screw shaft is provided with an axial hole, the surface of the screw shaft is provided with a radial hole in communication with the axial hole, and an end portion of the screw shaft not having an axial hole is connected to the power device. The filter disc body is fixed to the screw shaft, a central axis of the filter disc body coincides with a central axis of the screw shaft, the radial hole is provided at a position where the filter disc body is fixed to the screw shaft, and a filtrate flowing into the filter disc body enters the axial hole through the radial hole of the screw shaft and is discharged outwardly from the sealed cavity.

The high-pressure filter further comprises a spiral stirring device and a compressed air storage tank. The spiral stirring device is built in the bottom of the trough and under the filter disc. The compressed air storage tank is externally placed on the sealed housing, and an outlet end of the compressed air storage tank is in communication with the sealed cavity downwardly.

Optionally, the high-pressure filter further comprises a scraper and a screw discharging device. The scraper is mounted to the trough or the inner wall of the sealed housing, the scraper is located at a side of the filter disc, the screw discharging device is externally disposed on the sealed housing, and a feeding end of the screw discharging device is in communication with the sealed cavity upwardly. When the power device drives the filter disc to rotate, the scraper scrapes off a filter cake on the surface of the filter disc so that the filter cake falls from the sealed cavity into the feeding end of the screw discharging device.

Optionally, the filter disc body includes a support plate and a sintered mesh tightly wrapped around an outer surface of the support plate. The support plate is a disc structure having an intermediate opening. The support plate includes a first support plate body, a second support plate body, and a seal ring. Surfaces of the first support plate body and the second support plate body are provided with a plurality of through holes, the first support plate body and the second support plate body are symmetrically parallel, the seal ring is located between the first support plate body and the second support plate body, and the seal ring is sealingly connected to outer edges of the first support plate body and the second support plate body.

Optionally, the sintered mesh includes a protective layer, a filter layer, a flow guiding layer, and a base layer in sequence from the outside in, and the pore density of the filter layer is much smaller than the pore densities of the protective layer, the flow guiding layer, and the base layer.

Preferably, the support plate is selected from a perforated plate or engineering plastic. Preferably, the number of the screw shaft is one, and the number of the filter disc body is 1 to 20.

Optionally, the number of the screw shaft is at least two, a screw shaft connected to the power device is provided with an axial hole, the other screw shaft is provided with an axial through hole, and adjacent screw shafts are arranged in series and screwed to form a linear filtering passage; the number of the filter disc body is the same as the number of the screw shaft, and the filter disc bodies are fixed to the screw shafts one-to-one correspondingly.

Optionally, the surface of the sealed housing is provided with a sight glass.

Optionally, the high-pressure filter further comprises a backwashing system. The backwashing system is located at an axial hole end of the screw shaft, and a water outlet end of the backwashing system is fitted to the axial hole of the screw shaft.

Optionally, the screw shaft is connected to the sealed housing through the bearing block, and a mechanical seal is mounted between the bearing block and the sealed housing.

The beneficial effects of a high-pressure filter of the present invention compared to the prior art are as follows.

1) The present invention is simple in structure and small in volume. The inner wall of the sealed housing is connected to the outer wall of the trough to form the sealed cavity, the compressed air storage tank is in communication with the sealed cavity, and the compressed air is supplied to the sealed cavity to form a high pressure environment in the sealed cavity. Therefore, a pressure difference is formed between the interior and the exterior of the filter disc to improve the filtering efficiency.

2) The filter disc of the present invention can be enlarged to more than 20 square meters per turn. The sintered mesh is used as a filter material, which has uniform and stable filtering precision and extremely high mechanical strength and compressive strength. The filtering mechanism is surface filtering, and pores of the mesh are smooth, so the filter disc has excellent backwash regeneration performance, and can be used repeatedly for a long time. Backwash is required for only one minute once every 4 to 8 hours, and does not need pickling or shutdown, thus being especially suitable for continuous and automated operations.

3) The filter of the present invention has the advantages of small volume and high filtering efficiency, and the backwashing system can also reduce the probability of clogging accidents in the filtering process and the use cost, increase the filtering time, and improve the throughput.

### BRIEF DESCRIPTION OF THE DRAWINGS

FIG. 1 is a structural front view of Embodiment 1 according to the present invention;

FIG. 2 is a cross-sectional view taken along the line M-M of FIG. 1;

FIG. 3 is a partially enlarged cross-sectional structural view of a filter disc according to Embodiment 1;

FIG. 4 is an enlarged structural view of A in FIG. 3;

FIG. 5 is an enlarged view of a partial surface of a first perforated plate body of FIG. 3;

FIG. 6 is an enlarged structural view of B in FIG. 3; and

FIG. 7 is a partially enlarged cross-sectional structural view of the filter disc according to Embodiment 2.

Reference numerals in the drawings each denote:

100. Backwashing system, 200. Trough, 300. Filter disc, 400. Power device,

500. Scraper, 600. Screw discharging device, 700. Compressed air storage tank,

800. Spiral stirring device;

210. Sealed housing, 220. Sealed cavity, 230. Liquid inlet, 240. Sight glass;

310. Screw shaft, 311. Axial hole, 312. Radial hole, 313. Axial through hole;

320. Filter disc body, 330. Perforated plate, 340. Sintered mesh;

331. First perforated plate body, 332. Second perforated plate body, 333. Seal ring,

334. Through hole, 335. Groove;

510. Blade;

341. Protective layer, 342. Filter layer, 343. Flow guiding layer, 344. Base layer;

A. Ultrasonic liquid level controller, b. Filter cake thickness ultrasonic detector;

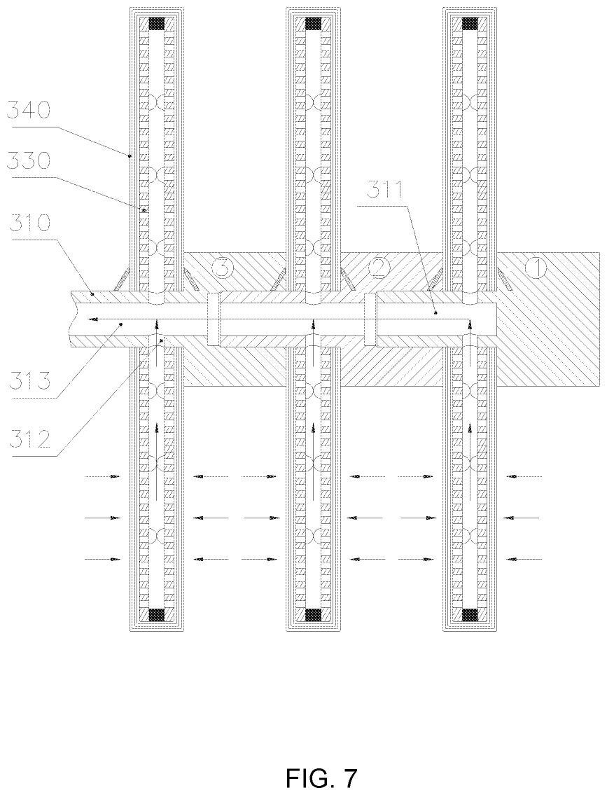

reference numerals \textcircled{1}\textcircled{2}\textcircled{3} in FIG. 7 denote screw shafts which are sequentially connected in series, wherein a right end of the screw shaft denoted by the reference numeral \textcircled{1} is connected to the power device.

### DETAILED DESCRIPTION

Exemplary embodiments of this disclosure will be described in more detail below with reference to the accompanying drawings of the specification. Exemplary embodiments of this disclosure are shown in the accompanying drawings of the specification; however, it should be understood that this disclosure can be implemented in various forms rather than being limited by the embodiments described here. In contrast, these embodiments are provided so that this disclosure can be understood more thoroughly and the scope of this disclosure can be fully conveyed to those skilled in the art.

In order to better illustrate the present invention, the technical solution will be further described now in conjunction with the specific embodiments and the accompanying drawings. These specific embodiments are described in the embodiments; however, they are not intended to limit the present invention. Some variations and modifications can be made by any of ordinary skill in the art without departing from the spirit and scope of the present invention. Therefore, the protection scope of the present invention should be subject to that defined by the claims.

### Embodiment 1

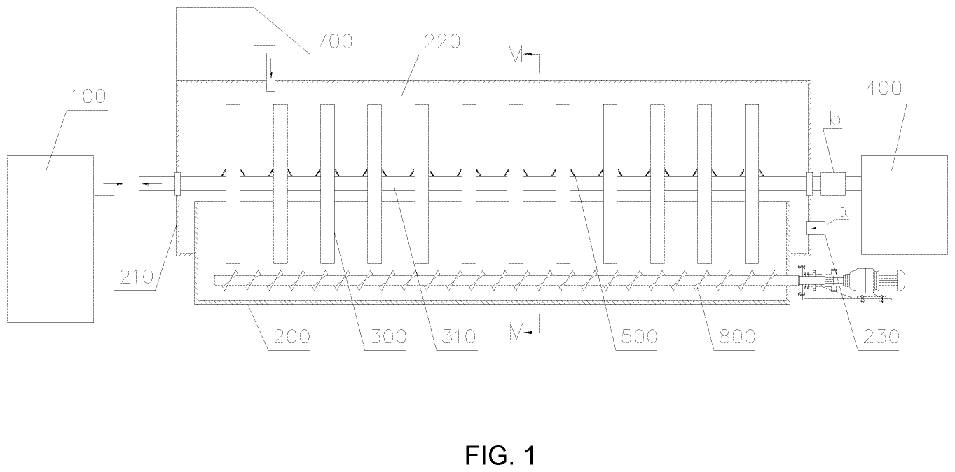

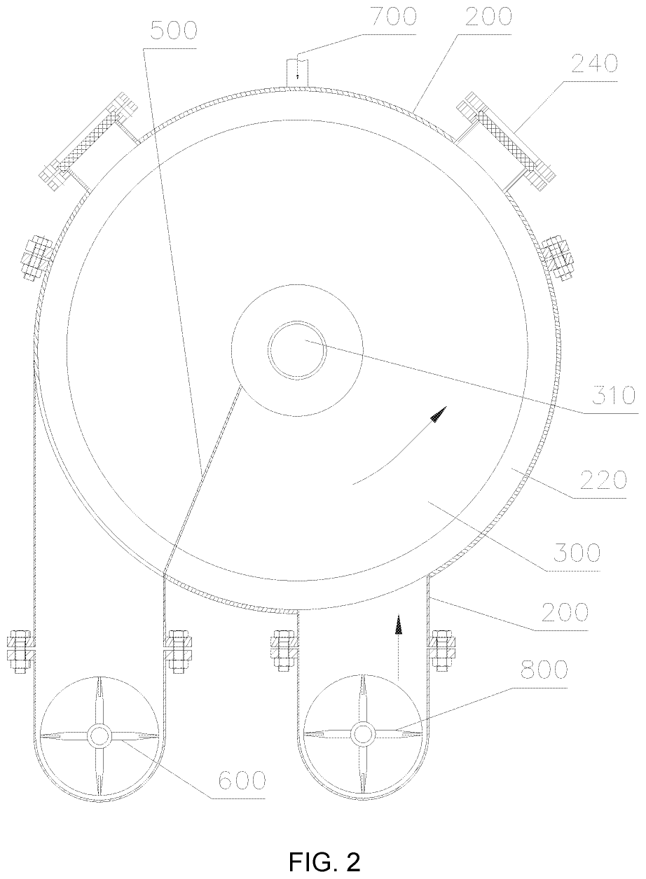

As shown in FIG. 1 and FIG. 2, the present invention provides a high-pressure filter, including a slurry filled trough 200, a filter disc 300 built into the trough 200, and a power device 400 for driving the filter disc 300 to rotate about its own axis. A sealed housing 210 is disposed outside the trough 200, and an inner wall of the sealed housing 210 is connected to an outer wall of the trough 200 to form a sealed cavity 220, the surface of the sealed housing 210 is provided with a liquid inlet 230 in communication with the sealed cavity 220, and an ultrasonic liquid level controller a is mounted at the position of the liquid inlet 230.

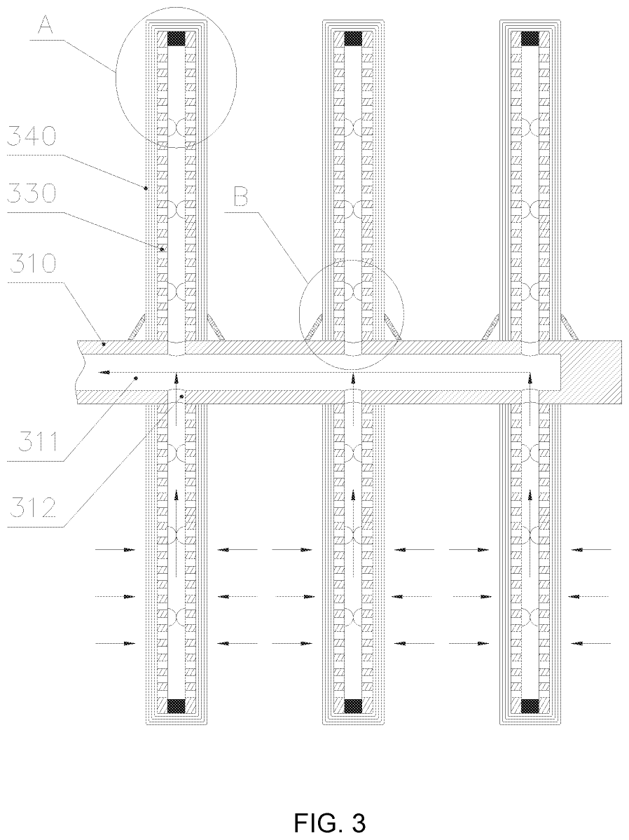

As shown in FIG. 3 to FIG. 6, in order to achieve good filtering, the structure of the filter disc 300 specifically includes a screw shaft 310 and twelve filter disc bodies 320. Two ends of the screw shaft 310 penetrate through the sealed housing 210 outwardly through a bearing block, an end portion of the screw shaft 310 extending out of the sealed housing 210 is provided with a filter cake thickness ultrasonic detector b, a left end surface of the screw shaft 310 is provided with an axial hole 311, the surface of the screw shaft 310 is provided with twelve radial holes 312 in communication with the axial hole 311, and a right end portion of the screw shaft 310 is connected to the power device. The filter disc body 320 is fixed to the screw shaft 310, a central axis of the filter disc body 320 coincides with a central axis of the screw shaft 310, the radial hole 312 is provided at a position where the filter disc body 320 is fixed to the screw shaft 310, and a filtrate flowing into the filter disc body 320 enters the axial hole 311 through the radial hole 312 of the screw shaft 310 and is discharged outwardly from the sealed cavity 220.

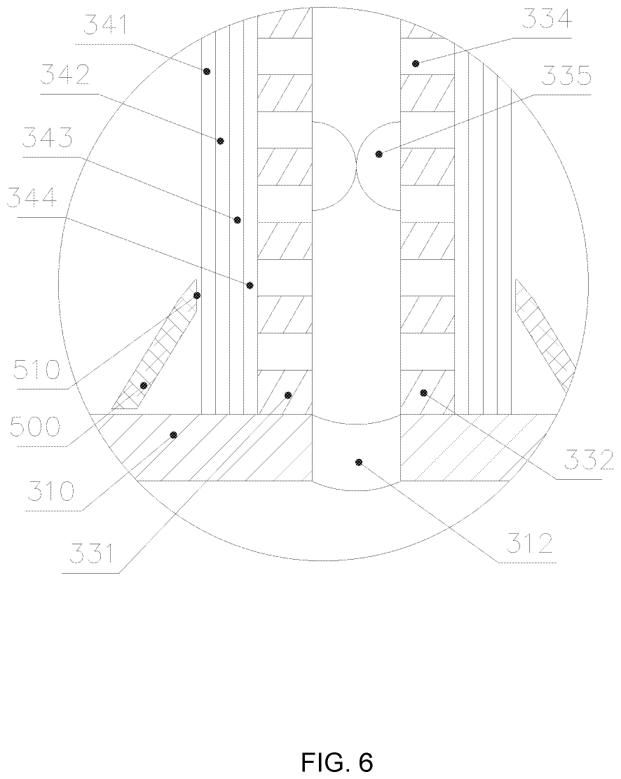

As shown in FIG. 3 and FIG. 6, a perforated plate body is used as an example in this embodiment. The filter disc body 320 includes a perforated plate 330 for supporting and a sintered mesh 340 tightly wrapping the perforated plate 330.

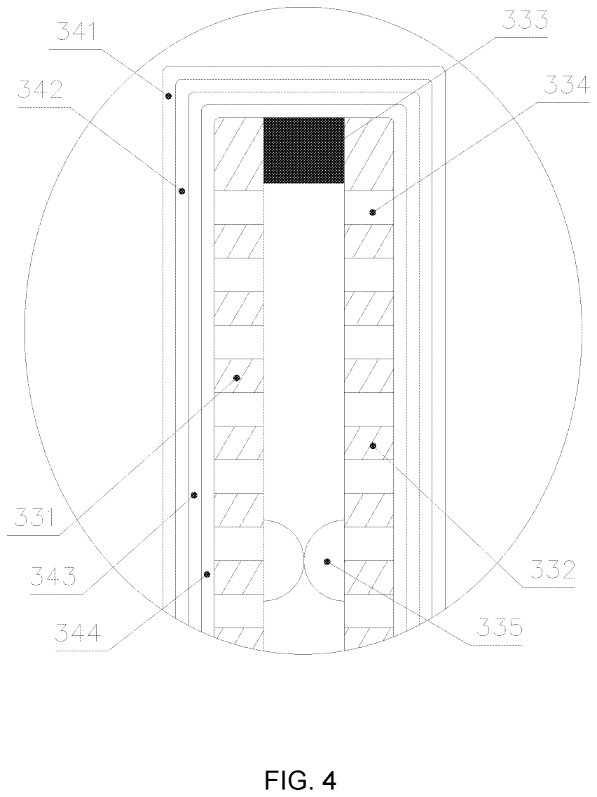

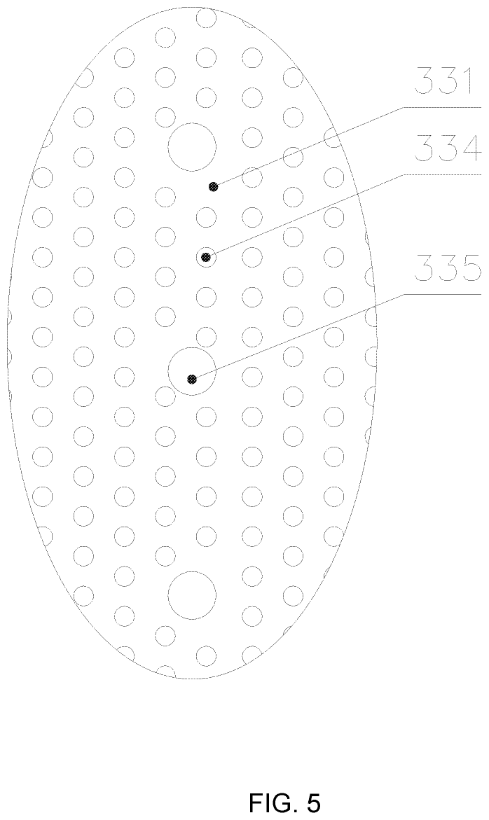

As shown in FIG. 3, FIG. 4, FIG. 5, and FIG. 6, the perforated plate 330 is a disc structure having an intermediate opening, and the sintered mesh 340 is tightly wrapped around an outer surface of the perforated plate 330. The perforated plate 330 includes a first perforated plate body 331, a second perforated plate body 332, and a seal ring 333. Surfaces of the first perforated plate body 331 and the second perforated plate body 332 are provided with a plurality of through holes 334 respectively. The first perforated plate body 331 and the second perforated plate body 332 are symmetrically parallel. The seal ring 333 is located between the first perforated plate body 331 and the second perforated plate body 332, and the seal ring 333 is sealingly connected to outer edges of the first perforated plate body 331 and the second perforated plate body 332. As such, liquid after being filtered by the filter disc body 320 will pass through the sintered mesh 340, and then enter a filtering cavity enclosed by the first perforated plate body 331, the second perforated plate body 332, and the seal ring 333. Finally, the liquid flows into the axial hole 311 through the radial holes 312 of the screw shaft 310, and is then discharged from the sealed cavity outwardly. It should be noted that a plurality of grooves 335 may further be disposed on the surfaces of the first perforated plate body 331 and the second perforated plate body 332, thus better implementing the connection between the first perforated plate body 331, the second perforated plate body 332, and the seal ring 333. The plurality of grooves 335 are classified into at least two groups. Adjacent grooves 335 in the same group are connected to form a straight line perpendicular to the central axis of the screw shaft 310. The through holes 334 are located between grooves 335 in adjacent groups. The grooves 335 in different perforated plate bodies are welded, thus implementing fixed connection between the first perforated plate body 331 and the second perforated plate body 332, thereby implementing the fixed connection between the first perforated plate body 331, the second perforated plate body 332, and the seal ring 333.

As shown in FIG. 3 and FIG. 6, the sintered mesh 340 includes a protective layer 341, a filter layer 342, a flow guiding layer 343, and a base layer 344 in sequence from the outside in, and the pore density of the filter layer 342 is much smaller than the pore densities of the protective layer 341, the flow guiding layer 343, and the base layer 344.

As shown in FIG. 1 and FIG. 2, the high-pressure filter further includes a spiral stirring device 800 and a compressed air storage tank 700. The spiral stirring device 800 is built in the bottom of the trough 200 and under the filter disc 300; the compressed air storage tank 700 is externally placed on the sealed housing 210, and an outlet end of the compressed air storage tank 700 is in communication with the sealed cavity 220 downwardly

As shown in FIG. 1 and FIG. 2, the high-pressure filter further includes a scraper 500 and a screw discharging device 600. The scraper 500 is mounted to the trough 200 and located at a side of the filter disc 300. The screw discharging device 600 is externally disposed on the sealed housing 210, and a feeding end of the screw discharging device 600 is in communication with the sealed cavity 220 upwardly. When the power device drives the filter disc 300 to rotate, the scraper 500 scrapes off a filter cake on the surface of the filter disc 300 so that the filter cake falls from the sealed cavity 220 into the feeding end of the screw discharging device 600.

As shown in FIG. 1 to FIG. 6, in this embodiment, during operation, the power device 400 drives the screw shaft 310 to rotate, the filter disc 300 rotates synchronously with the screw shaft 310, and the filter disc 300 filters the slurry in the trough 200 during the rotation. The sealed cavity forms a high-pressure environment under the action of the compressed air storage tank 700. The filtrate of the slurry filtered by the filter disc 300 enters the filtering cavity enclosed by the first perforated plate body 331, the second perforated plate body 332, and the seal ring 333, then flows into the axial hole 311 through the radial hole 312 of the screw shaft 310, and discharged from the sealed cavity through the axial hole 311 outwardly to achieve high pressure filtering. During the rotation of the filter disc 300, when the filter disc 300 leaves the slurry, a filter cake is formed on the surface of the filter disc 300 due to the accumulation of slurry impurities. When the filter disc 300 is rotated again to be immersed in the slurry, the scraper 500 fixed to the trough 200 scrapes off a filter cake formed on the surface of the filter disc 300, and the filter cake falls under the guiding action of the scraper 500 from the sealed cavity 220 into the feed end of the screw discharging device 600. Therefore, the filter disc 300 immersed in the slurry can better carry out the filtering work.

### Embodiment 2

Referring to FIG. 7 with reference to FIG. 1 to FIG. 6, the difference from Embodiment 1 is that the number of the screw shaft 310 is at least two. With reference to Embodiment 1, the number of the screw shaft 310 should be twelve. The rightmost screw shaft 310 is connected to the power device 400, and is provided with an axial hole 311. The other screw shafts 310 are provided with axial through hole 313, and adjacent screw shafts 310 are arranged in series and screwed to form a linear filtering passage. The number of the filter disc body 320 is the same as the number of the screw shaft 310, and the filter disc bodies 320 are fixed to the screw shafts 310 one-to-one correspondingly.

The filter further includes a backwashing system 100. The on and off of the backwashing system 100 is controlled by a PLC system. The backwashing system 100 is located at the axial hole 311 end of the screw shaft 310, and a water outlet end of the backwashing system 100 is in communication with the axial hole 311 of the screw shaft 310. In addition to the scraper 500 scraping off the filter cake formed on the surface of the filter disc 300, the filter disc 300 can also be backwashed by the backwashing system 100. The PLC system is operated, the backwashing system 100 is activated, and the water outlet end of the backwashing system 100 is connected to the axial hole 311 of the screw shaft 310. The water discharged by the backwashing system 100 flows through the axial hole 311 of the screw shaft 310, the radial hole 312 of the screw shaft 310, enters the filtering cavity enclosed by the first perforated plate body 331, the second perforated plate body 332, and the seal ring 333, and then passes through the through holes 334 on the surfaces of the first perforated plate body 331 and the second perforated plate body 332 and through the sintered mesh 340 outwardly, thereby achieving backwashing of the filter disc 300, improving the filtering effect, and avoiding the occurrence of clogging.

In addition, for Embodiment 1 and Embodiment 2, it is necessary to supplement that the support plate can also be selected from engineering plastic with high strength and corrosion resistance. The surface of the engineering plastic is also provided with a plurality of through holes. The structure layout and the installation are all identical to the structural layout and the installation of the perforated plate, and will not be elaborated here.

The present invention has been described according to a limited number of embodiments; however, being taught by the above description, those skilled in the art should understand that other embodiments can be conceived within the scope of the present invention as described.

In addition, it should be noted that the language used in the specification has been selected primarily for the purpose of readability and teaching, and is not selected for interpreting or limiting the theme of the present invention. Therefore, many modifications and variations without departing from the scope and spirit of the appended claims will be apparent to those of ordinary skill in the art. The disclosure of the present invention is intended to be illustrative rather than restrictive, and the scope of the present invention is defined by the appended claims.

1. A high-pressure filter, comprising: a slurry filled trough, a filter disc built into the trough, and a power device for driving the filter disc to rotate about its own axis; wherein a sealed housing is disposed outside the trough, and an inner wall of the sealed housing is connected to an outer wall of the trough to form a sealed cavity, the surface of the sealed housing is provided with a liquid inlet in communication with the sealed cavity, and an ultrasonic liquid level controller is mounted at the position of the liquid inlet;
the filter disc further comprises a screw shaft and a filter disc body;
two ends of the screw shaft penetrate through the sealed housing outwardly through a bearing block, an end portion of the screw shaft extending out of the sealed housing is provided with a filter cake thickness ultrasonic detector, an end surface of the screw shaft is provided with an axial hole, the surface of the screw shaft is provided with a radial hole in communication with the axial hole, and an end portion of the screw shaft not having an axial hole is connected to the power device;
the filter disc body is fixed to the screw shaft, a central axis of the filter disc body coincides with a central axis of the screw shaft, the radial hole is provided at a position where the filter disc body is fixed to the screw shaft, and a filtrate flowing into the filter disc body enters the axial hole through the radial hole of the screw shaft and is discharged outwardly from the sealed cavity; and
the high-pressure filter further comprises a spiral stirring device and a compressed air storage tank; the spiral stirring device is built in the bottom of the trough and under the filter disc; the compressed air storage tank is externally placed on the sealed housing, and an outlet end of the compressed air storage tank is in communication with the sealed cavity downwardly.

2. The high-pressure filter of claim 1, wherein the high-pressure filter further comprises a scraper and a screw discharging device; the scraper is mounted to the trough or the inner wall of the sealed housing, the scraper is located at a side of the filter disc, the screw discharging device is externally disposed on the sealed housing, and a feeding end of the screw discharging device is in communication with the sealed cavity upwardly; when the power device drives the filter disc to rotate, the scraper scrapes off a filter cake on the surface of the filter disc so that the filter cake falls from the sealed cavity into the feeding end of the screw discharging device.

3. The high-pressure filter of claim 1, wherein the filter disc body comprises a support plate and a sintered mesh tightly wrapped around an outer surface of the support plate, the support plate is a disc structure having an intermediate opening, the support plate comprises a first support plate body, a second support plate body, and a seal ring, surfaces of the first support plate body and the second support plate body are provided with a plurality of through holes, the first support plate body and the second support plate body are symmetrically parallel, the seal ring is located between the first support plate body and the second support plate body, and the seal ring is sealingly connected to outer edges of the first support plate body and the second support plate body.

4. The high-pressure filter of claim 3, wherein the sintered mesh comprises a protective layer, a filter layer, a flow guiding layer, and a base layer in sequence from the outside in, and the pore density of the filter layer is much smaller than the pore densities of the protective layer, the flow guiding layer, and the base layer.

5. The high-pressure filter of claim 3, wherein the support plate is selected from a perforated plate or engineering plastic.

6. The high-pressure filter of claim 1, wherein the number of the screw shaft is one, and the number of the filter disc body is 1 to 20.

7. The high-pressure filter of claim 1, wherein the number of the screw shaft is at least two, a screw shaft connected to the power device is provided with an axial hole, the other screw shaft is provided with an axial through hole, and adjacent screw shafts are arranged in series and screwed to form a linear filtering passage; the number of the filter disc body is the same as the number of the screw shaft, and the filter disc bodies are fixed to the screw shafts one-to-one correspondingly.

8. The high-pressure filter of claim 1, wherein the surface of the sealed housing is provided with a sight glass.

9. The high-pressure filter of claim 1, wherein the high-pressure filter further comprises a backwashing system, the backwashing system is located at an axial hole end of the screw shaft, and a water outlet end of the backwashing system is fitted to the axial hole of the screw shaft.

10. The high-pressure filter of claim 1, wherein the screw shaft is connected to the sealed housing through the bearing block, and a mechanical seal is mounted between the bearing block and the sealed housing.
